(19) United States
(12) Patent Application Publication
(10) Pub. No.: US 2015/0242963 A1
(43) Pub. Date: Aug. 27, 2015

(54) Method and Apparatus for Representing an Account Movement

(71) Applicant: Tobias Schüle, Munchen (DE)

(72) Inventor: Tobias Schüle, Munchen (DE)

(21) Appl. No.: 14/632,515

(22) Filed: Feb. 26, 2015

(30) Foreign Application Priority Data
Feb. 27, 2014 (DE) 102014203579.1

(51) Int. Cl. G06Q 40/00

(52) U.S. Cl. CPC G06Q 40/12

(57) ABSTRACT

The embodiments relate to a method for electronically representing an account movement. The method includes representing an account movement with at least the following information elements: (1) date of the account movement, (2) reason for the account movement, and (3) amount of the sum of money involved in the account movement. The method further includes representing a further information element that may be used to obtain the information about the location at which a monetary transaction on which the account movement is based took place. The embodiments also relate to an apparatus for ascertaining data for the representation of an account movement and to a communication terminal.

### CROSS-REFERENCE TO RELATED APPLICATIONS

This application claims the benefit of DE 10 2014 203 579.1, filed on Feb. 27, 2014, which is hereby incorporated by reference in its entirety.

### TECHNICAL FIELD

The embodiments relate to a method and an apparatus for representing an account movement.

### BACKGROUND

Online banking refers to the handling of monetary transactions via data lines or wirelessly using electronic terminals, such as PCs, smartphones, or other telecommunication appliances. Orders therefor are signed by an electronic signature. By way of example, this signature may include a PIN and/or TAN or of a “natural” signature that is put at the bottom of the invoice that has been produced by a payment terminal.

Particularly in the case of online banking, there are a series of opportunities for fraud, since there are a large number of opportunities to tap off the PIN, TAN, account number, and other identifiers that are required for a monetary transaction.

An account for the payment transactions of a user is used to deposit or withdraw funds, to make transfers, and to make debits, for example. These entries result in movements in the account of the user, namely an outflow of money in the case of payments, withdrawals or transfers, for example, or an inflow in the case of credits or deposits, for example.

In order to prevent abuse, (e.g., the making of unwarranted entries), regular inspection of these account movements is required. Inspection may be difficult to perform, however, particularly if there are a very large number of account movements present. This is also true particularly when the account statement is represented in electronic form, e.g., not on a paper printout.

### SUMMARY AND DESCRIPTION

The scope of the present invention is defined solely by the appended claims and is not affected to any degree by the statements within this summary. The present embodiments may obviate one or more of the drawbacks or limitations in the related art.

It is therefore an object of the present embodiments to provide a way of simplifying the inspection of an account movement.

The representation of an account movement additionally involves the display of a further piece of information that may be used to obtain geographical information about the location at which the monetary transaction on which the entry is based took place. This additional geographical information firstly allows the account holder to remember the monetary transaction better and secondly allows abuse to be established more easily, for example, when the account holder was not at that location at the relevant time. This simplifies a plausibility check for the account audit.

An account movement is understood to refer to a change in the account on the basis of a monetary transaction.

Electronic representation refers to a representation that is not present on a printout, particularly not on a paper printout, but rather by an electronic display unit, for example, the screen of a computer or the display of a communication terminal such as a smartphone.

According to one embodiment, a symbol that represents a map, in particular, is depicted, for an entry as further information besides information concerning time, purpose, and amount of the payment, and clicking on the symbol displays the map. Given appropriate denotation of the location at which the event that was the cause of the account movement took place, it is thus possible for an account holder to quickly inspect whether the corresponding entry was correct, namely because he himself withdrew the money or made a purchase at the stated company, for example.

According to another embodiment, the further information element is used to set up a link to a map application to which location information that the further information element contains or that may be obtained by the latter is transferred.

According to an advantageous embodiment, the geographical information obtained by the further information element is compared with further location information provided by the account holder. This allows an automatic consistency check for the location data, which further simplifies inspection of the account movements.

The location information provided by the user may originate particularly from data that originate from the use of an electronic appliance that the user carries.

An apparatus is additionally provided that may be used to ascertain data for representing an account movement, as is a communication terminal that has such an apparatus.

### BRIEF DESCRIPTION OF THE DRAWINGS

FIG. 1 depicts an embodiment of an apparatus for representing account movements with the appropriate interfaces, which are depicted schematically.

FIG. 2 depicts an exemplary implementation of the apparatus schematically depicted in FIG. 1.

FIG. 3 depicts a representation of account movements with an information element that may be used to obtain geographical information.

### DETAILED DESCRIPTION

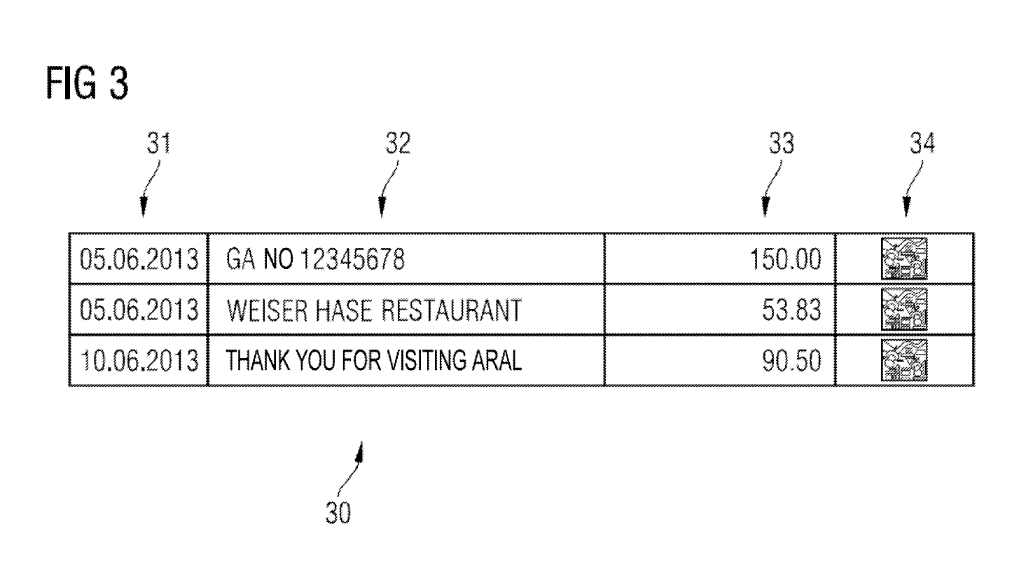

FIG. 3 depicts an electronic account statement that includes three account movements. For each account movement, the date of the entry or transaction 31, the reason for the entry or the purpose 32, the sum of money 33 in question, and a further information element 34 are depicted.

The purpose 32 depicted may not suffice to check the plausibility of the sum of money 33 in question, for example because the account holder fills up at Aral more often than once, cf. row 3, or because the number of the automated teller machine at which the account holder made a withdrawal is not sufficient for him to remember whether he was actually at the automated teller machine in question.

The information element 34 in column 4 now allows further geographical information to be used to verify the individual payment process. In the case of the account movement in row 1, clicking on the information element 34, which is embodied as a symbol in FIG. 3, displays a map of the surroundings in which the automated teller machine in question is located. The further information element 34 may thus be embodied as a link, in particular, that leads to a map of the location in question or opens a map application and transfers the location coordinates as parameters therefor. This allows the account holder to remember more easily whether he was at the denoted location on the stated day and withdrew money at that location.

Similarly, in the case of a card payment in a restaurant as in row 2, a map of the surroundings of the restaurant in question is displayed, so that the plausibility may be checked more easily. If, by way of example, a location in Hamburg is now depicted as surroundings for the payment at the filling station in row 3, even though the account holder was in Munich, it is easy to establish that an unwarranted payment or fraud is possibly involved.

According to one alternative embodiment, clicking on the information element 34 embodied as a symbol does not open a map, but rather calls a map application with the corresponding position, for example Google Maps.

According to another embodiment, clicking on the information element 34 embodied as a symbol transmits an identifier to the bank with which the account is held that may be used to explicitly identify the entry. On the basis of this identifier, the bank then determines the coordinates and displays them on a map, for example.

In order to implement this functionality, the bank stores the geographical coordinates for all automated teller machines. Alternatively, or in addition, location data for automated teller machines, business, restaurants, and the like are accessed. This has the advantage that the bank does not need to keep these data itself.

When a smartphone is used as a terminal, the interface used for setting up a connection to a database may also be a radio module of the terminal. Alternatively, a corresponding database may be in place on the terminal.

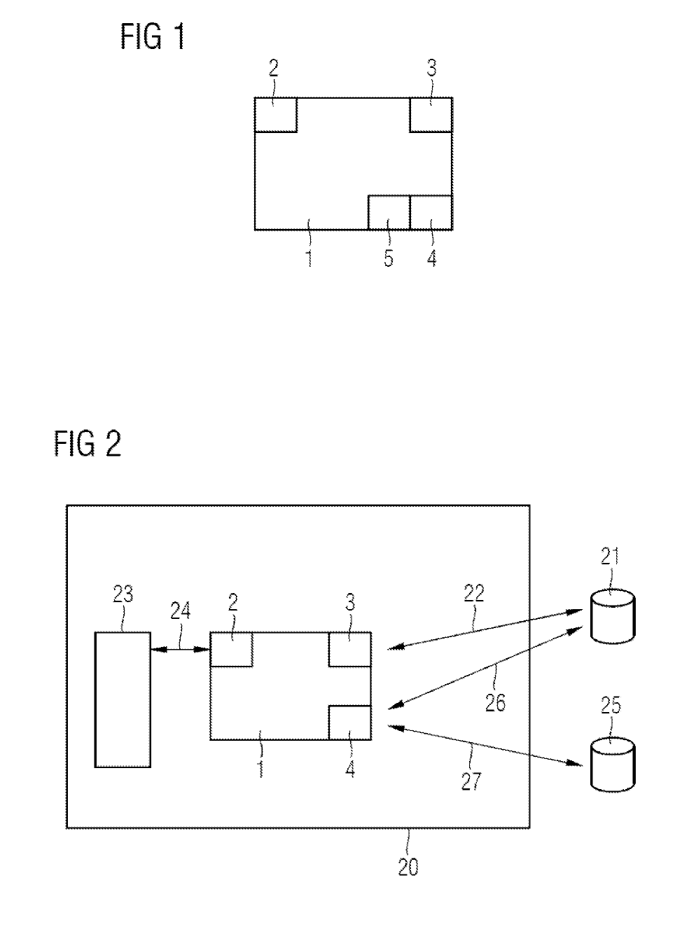

FIG. 1 schematically depicts an apparatus 1 for ascertaining data for representing account movements, such as an account statement as depicted in FIG. 3.

The apparatus 1 has at least one output unit interface or first interface 2 that may be used to set up a connection to an output unit, for example, an electronic display.

The output unit may be the display of a communication terminal that the apparatus may use to communicate wirelessly or by wire.

In addition, this first interface 2 may be used to receive messages from the output unit or to request further information. According to one embodiment, clicking on the further information element 34 makes the request for location information via the output interface 2.

Furthermore, the apparatus 1 has an account data interface or second interface 3 that may be used to request account data from a data server in a bank, for example. According to one embodiment, this involves the use of wireless or wired communication by a terminal, wherein the communication may be encrypted.

Furthermore, the apparatus 1 has a location ascertainment interface or a third interface 4 that may be used to provide a connection to a computation unit and/or a data memory that is/are used to obtain the location information. Hence, the apparatus 1 may be used to combine the data that are required for producing an account statement 30.

Optionally, a fourth interface 5 is provided that may be used to obtain location data, for example, movement profiles, (e.g., at what time the owner of the smartphone was at what location), that are ascertained by an electronic appliance, for example, a smartphone. This has the advantage that a consistency check for entry data and coordinates, e.g., for the geographical information associated with the entry against the movement profile ascertained by the electrical appliance, that is to say geographical data determined independently thereof, is possible.

FIG. 2 depicts an embodiment of the apparatus schematically depicted in FIG. 1. In this case, the apparatus 1 is implemented in a communication terminal 20 that may be embodied as a computer, notebook, smartphone, or other communication terminal, for example.

The first interface 2 allows output on an output unit 23 of the terminal 20. There is provision for data interchange 24 between the output unit 23 and the first interface 2, the data interchange being able to take place in one or both directions.

The second interface 3 allows communication via a data link 22 with a data server 21 that stores the account data, particularly the entries for the sum of money entered, optionally for the purpose of the order and also for a piece of information that may be used to obtain a piece of geographical information.

The data link 22 may be secure and may be provided in one direction or as duplex.

An identifier for the location is obtained from the database server 21 via a data link 26, and a further data link 27 is used to obtain the map or map application from a further data server 25.

In particular, the second interface 3 and the third interface 4 and/or the data server 21 and the data server 25 may be combined in this case.

Alternatively, the location information that may be obtained via the third interface 4 may likewise be obtained from the data server 21.

The data server 25 is located outside the communication terminal 20. Alternatively or in addition, a data server is provided inside the communication terminal 20.

According to one advantageous exemplary embodiment, the apparatus 1 is provided in a terminal 20 whose displays and interfaces are used. The output unit interface 2 is used to control the display of the terminal 20 and to accept commands that are input on the display or on a separate keyboard. The account data interface 3 is used to obtain the account data, in certain embodiments, via a secure connection, (e.g., encrypted connection), by a radio module or communication module for wired transmissions from the terminal. The location ascertainment interface 4 is used to obtain geographical information associated with the entry, for example, by accessing a memory located in or outside the terminal.

The terminal 20 obtains GPS data or other location information, for example, provided by base stations or radio beacons, from the apparatus 1. This location information may be combined to form a movement profile, which is to say to form a representation of the location in comparison with the time.

According to one exemplary embodiment, a movement profile includes the hourly capture of the GPS information for the stopover by the user. At particular intervals, for example, when balancing an account, or at the end of a day, the bank sends the date and the coordinates for each withdrawal or card payment to the smartphone. A check is then performed, following manual initiation or automatically, to determine whether this information matches the stored movement profile. Advantageously, a warning is output if the location of the withdrawal or card payment does not match a location that is compatible with the movement profile. In particular, the warning may be in the form of visual advice through appropriate highlighting of the accounting record, with the optional addition of an explanation, or in the form of audible advice.

The compatibility of the geographical information may be ascertained in the terminal itself. This has the advantage that the user may be provided with information immediately without further data transmissions. In particular, it is thus possible to avoid sending his movement profile to other entities.

Alternatively or in addition, the compatibility may be ascertained on a computation unit associated with the bank. This has the advantage, particularly when the consistency check for the geographical information takes place in real time, that an entry may still be avoided.

The compatibility may be ascertained by taking account of a movement profile for the user. According to one embodiment, a radius of movement of the user is ascertained from a movement profile that is available for a period of time. If the geographical information on which the entry is based is within this radius of movement, with a tolerance value being able to be added, the entry is classified as plausible. The period of time and the tolerance value may be chosen in variable fashion, particularly in a manner that may be set by the user. This allows individual movement profiles to be taken into account, for example, whether the user often travels by air or rather changes location on foot.

It is to be understood that the elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent, and that such new combinations are to be understood as forming a part of the present specification.

While the present invention has been described above by reference to various embodiments, it may be understood that many changes and modifications may be made to the described embodiments. It is therefore intended that the foregoing description be regarded as illustrative rather than limiting, and that it be understood that all equivalents and/or combinations of embodiments are intended to be included in this description.

1. A method for electronically representing an account movement, the method comprising:
representing an account movement with at least the following information elements: date of the account movement. reason for the account movement, and amount of the sum of money involved in the account movement; and
representing a further information element configured to obtain information about a location of a monetary transaction on which the account movement is based took place.

2. The method as claimed in claim 1, wherein the further information element comprises a link to a map.

3. The method as claimed claim 2, wherein the further information element comprises a map application, wherein maps for the location are transferred to the map application.

4. The method as claimed in claim 3, further comprising:
comparing the location information that may be obtained from the further information element with user location information that is ascertained using an electronic appliance of an account user.

5. The method as claimed in claim 4, further comprising:
outputting a warning to the account user when the comparison establishes a discrepancy.

6. The method as claimed in claim 5, wherein the discrepancy is ascertained by virtue of a radius of movement being derived from the user location information in a prescribed interval of time and being established whether the location of the transaction is within the radius of movement plus a tolerance distance.

7. The method as claimed in claim 6, wherein the interval of time and the tolerance distance are selected by the user.

8. The method as claimed claim 1, wherein the further information element comprises a map application, wherein maps for the location are transferred to the map application.

9. The method as claimed in claim 1, further comprising:
comparing the location information that may be obtained from the further information element with user location information that is ascertained using an electronic appliance of an account user.

10. The method as claimed in claim 9, further comprising:
outputting a warning to the account user when the comparison establishes a discrepancy.

11. The method as claimed in claim 10, wherein the discrepancy is ascertained by virtue of a radius of movement being derived from the user location information in a prescribed interval of time and being established whether the location of the transaction is within the radius of movement plus a tolerance distance.

12. The method as claimed in claim 11, wherein the interval of time and the tolerance distance are selected by the user.

13. An apparatus for ascertaining data for the representation of an account movement, the apparatus comprising:
a first interface for transmitting, receiving, or transmitting and receiving data from an output unit on which the account movement is configured to be represented;
a second interface configured to obtain information concerning the account movement; and
a third interface configured to obtain information concerning the location of the account movement.

14. The apparatus as claimed in claim 13, further comprising a fourth interface to an electrical appliance that ascertains stopover data.

15. A communication terminal comprising:
a display apparatus; and
an apparatus comprising: (1) a first interface for transmitting, receiving, or transmitting or receiving data from an output unit on which the account movement is configured to be represented, (2) a second interface configured to obtain information concerning the account movement, and (3) a third interface configured to obtain information concerning the location of the account movement.

16. The communication terminal as claimed in claim 15, wherein the apparatus further comprises a fourth interface to an electrical appliance that ascertains stopover data.
